(19) United States
(12) Patent Application Publication
(10) Pub. No.: US 2025/0259763 A1
(43) Pub. Date: Aug. 14, 2025

(54) MIRROR ARRANGEMENT FOR MAGNETO-OPTICAL TRAP

(71) Applicant: Atomionics Pte Ltd, Singapore (SG)

(72) Inventors: Akshay Anandrao SONANDKAR, Singapore (SG); Ravi KUMAR, Singapore (SG); Shijie CHAI, Singapore (SG)

(73) Assignee: Atomionics Pte Ltd, Singapore (SG)

(21) Appl. No.: 18/725,706

(22) PCT Filed: Jan. 25, 2024
(86) PCT No.: PCT/SG2024/050047

§ 371 Date: Jun. 28, 2024

(30) Foreign Application Priority Data
Jan. 26, 2023 (SG) 10202300201U

(51) Int. Cl. G21K 1/00

(52) U.S. Cl. CPC G21K 1/006

(57) ABSTRACT

Mirror arrangements for a magneto-optical trap are described. A mirror arrangement comprises: a first deflector mirror; a second deflector mirror; a first combiner mirror; and a second combiner mirror. The mirrors are arranged to provide two orthogonal counter propagating beam pairs in a plane. A second mirror arrangement additionally comprises a third deflector mirror; a fourth deflector mirror; a third combiner mirror; and a fourth combiner mirror. The mirrors are arranged to provide three orthogonal counter propagating beam pairs.

### TECHNICAL FIELD

The present disclosure relates to magneto-optical traps and in particular to the arrangements of mirrors in a magneto-optical trap.

### BACKGROUND

Laser cooled-trapped atoms are used in cold atom sensors (quantum sensors) that are used for measuring acceleration, rotation, magnetic fields and studying fundamental physics etc. These sensors are used for navigation, gravimetry, oil and gas and resource exploration. These sensors are also used in tunnel planning, infrastructure development and city planning. Cold atom gravimeters are also used to predict earthquakes and monitor volcanic activities.

Atoms can be cooled and trapped in a Magneto-Optical Trap (MOT) to a temperature of tens of micro-Kelvin with intersecting counter-propagating laser beams from three orthogonal axes in the presence of a magnetic field. With sub-doppler cooling mechanisms, the temperature can further be brought down to micro-Kelvin level. In the presence of 6 circularly polarized counter-propagating laser beams and spatially-varying magnetic field, gaseous atoms get effective momentum kicks in the opposite direction of their motion and towards the trap center. This slows them down in speed and traps them at the center of the MOT. Typically, MOTs are formed with a set of 6 laser beams intersecting at one place.

### SUMMARY

According to a first aspect of the present disclosure, a mirror arrangement for a MOT is provided. The mirror arrangement comprises: a first deflector mirror; a second deflector mirror; a first combiner mirror; and a second combiner mirror. The first deflector mirror is arranged to deflect part of a source beam, from a direction along an optical axis of the mirror arrangement to a first deflected direction, in a first plane, towards the first combiner mirror, as a first deflected beam. The first combiner mirror is arranged to deflect the first deflected beam, in a first orthogonal direction in the first plane which is orthogonal to the direction of the source beam, as a first orthogonal beam. The second deflector mirror is arranged to deflect part of the source beam, from the direction along the optical axis of the mirror arrangement, to a second deflected direction, in the first plane, towards the second combiner mirror, as a second deflected beam. The second combiner mirror is arranged to deflect the second deflected beam, in a second orthogonal direction in the first plane which is orthogonal to the direction of the source beam, as a second orthogonal beam. The second combiner mirror is arranged to deflect the first orthogonal beam as a first re-deflected beam in a direction towards the second deflector mirror. The second deflector mirror is arranged to deflect the first re-deflected beam as part of an outgoing beam in a direction opposing the direction of the source beam. The first combiner mirror is arranged to deflect the second orthogonal beam as a second re-deflected beam in a direction towards the first deflector mirror. The first deflector mirror is arranged to deflect the second re-deflected beam as part of the outgoing beam, such that the source beam and the outgoing beam form a first counter propagating beam pair in a trap location and the first orthogonal beam and the second orthogonal beam form a second counter propagating beam pair in the trap location which is orthogonal to the first counter propagating beam pair.

The mirror orientation generates more axes of counter propagating beams on top of the conventional orthogonal beams. The added axes and the shape of the mirror assembly increases the beam intersection volume that enhances laser cooling efficiency and reduces the optical power requirements. The mirror assembly also allows laser cooling of atoms with just two or one (in 3D mirror configuration) laser collimators. The mirror arrangement makes the mechanical system of a cold atom sensor simple, modular and compact. The design gives flexibility to keep the mirror assembly fully or partially inside or outside of the vacuum chamber, which makes mechanical assembly and alignment easier.

The formation of a MOT is dependent on the appropriate polarization of the laser beams with respect to the direction of the magnetic fields. Quality of the MOT such as temperature, loading time, size and number of atoms in the MOT are dependent on the alignment of laser beams and their intersection volume. More intersection volume leads to better MOT quality. Finally, the weight and size of the quantum sensor depends on the components and their quantities used in the system. For making specific observations or manipulations to the MOT, clear view/access is required in the MOT zone which is not obstructed by any reflective or an opaque surface.

The proposed mirror geometry performs well in all the above mentioned categories. The combinations of reflections in the mirror geometry naturally creates the required handedness of circular polarization. Compared to a regular pyramid mirror, the proposed geometry generates more intersection volume with beams in more than three counter propagating pairs thanks to the additional reflections. This design also allows the mirrors to be placed outside the vacuum chamber if needed, this thereby avoids complicated in-vacuum assembly and provides better access for easier and finer alignment tuning. In the proposed geometry, gaps may be provided between deflector and combiner mirrors for example. This clear access can be used to inject gaseous atoms, image and monitor MOT, shine lasers to impart momentum kicks or to do atom interferometry.

In an embodiment, the first deflector mirror and the second deflector mirror are adjacent to one another.

In an embodiment, the first deflector mirror, the second deflector mirror, the first combiner mirror and the second combiner mirror are provided as a single structure.

In an embodiment, a cut out section is provided between the first deflector mirror and the second deflector mirror.

In an embodiment, the cut out section is in the form of a hole or a slit.

In an embodiment, the mirror arrangement further comprises: a third deflector mirror; a fourth deflector mirror; a third combiner mirror; and a fourth combiner mirror. The third deflector mirror is arranged to deflect part of a source beam, from the direction along the optical axis of the mirror arrangement to a third deflected direction, in a second plane which is perpendicular to the first plane, towards the third combiner mirror, as a third deflected beam. The third combiner mirror is arranged to deflect the third deflected beam, in a third orthogonal direction in the second plane which is orthogonal to the direction of the source beam, as a third orthogonal beam. The fourth deflector mirror is arranged to deflect part of the source beam, from the direction along the optical axis of the mirror arrangement, to a fourth deflected direction, in the second plane, towards the fourth combiner mirror, as a fourth deflected beam. The fourth combiner mirror is arranged to deflect the fourth deflected beam, in a fourth orthogonal direction in the second plane which is orthogonal to the direction of the source beam, as a fourth orthogonal beam. The fourth combiner mirror is arranged to deflect the third orthogonal beam as a third re-deflected beam in a direction towards the fourth deflector mirror. The fourth deflector mirror is arranged to deflect the third re-deflected beam as part of the outgoing beam in the direction opposing the direction of the source beam. The third combiner mirror is arranged to deflect the fourth orthogonal beam as a fourth re-deflected beam in a direction towards the third deflector mirror. The third deflector mirror is arranged to deflect the fourth re-deflected beam as part of the outgoing beam, such that the third orthogonal beam and the fourth orthogonal beam form a third counter propagating beam pair in the trap location which is orthogonal to the first counter propagating beam pair and the second counter propagating beam pair.

In an embodiment, the first deflector mirror, the second deflector mirror, the third deflector mirror and the fourth deflector mirror are adjacent to one another.

In an embodiment, the first deflector mirror, the second deflector mirror, the third deflector mirror and the fourth deflector mirror form a pyramid shape.

In an embodiment, a cut out section is provided between the first deflector mirror, the second deflector mirror, the third deflector mirror and the fourth deflector mirror.

In an embodiment, a retro-mirror is provided to retro-reflect a light beam passing through the cut out section.

In an embodiment, the mirror arrangement further comprises a mirror and a quarter wave plate configured to change the polarization of the light beam passing through the cut out section.

In an embodiment, the first counter propagating beam pair, the second counter propagating beam pair and the third counter propagating beam pair (if applicable) are orthogonal within a tolerance of 1 degree, preferably within a tolerance of 0.1 degrees and more preferably within a tolerance of 0.01 degrees.

In an embodiment, a quarter wave plate is arranged between the deflector mirrors and the combiner mirrors. The quarter wave plate may be provided as a plurality of quarter wave plate sections each provided parallel to a respective deflector mirror. The quarter wave plate may be provided as a plurality of quarter wave plate sections each provided parallel to a respective combiner mirror.

According to a second aspect of the present disclosure, a MOT comprising the mirror arrangement set out above is provided.

In an embodiment, the MOT further comprises a vacuum chamber, wherein the mirror arrangement is provided within the vacuum chamber.

In an embodiment, the mirror arrangement is provided as a single structure.

In an embodiment, the MOT further comprises a vacuum chamber, wherein the mirror arrangement is provided outside the vacuum chamber.

In an embodiment, the mirror arrangement is provided as a plurality of separate components. The deflector mirrors and/or the combiner mirrors may be arranged inside the vacuum chamber.

In an embodiment, the MOT further comprises a source of gaseous atoms arranged to emit a stream of atoms through a gap between a defector mirror and a combiner mirror of the mirror arrangement.

### BRIEF DESCRIPTION OF THE DRAWINGS

In the following, embodiments of the present invention will be described as non-limiting examples with reference to the accompanying drawings in which:

FIG. 1 shows a mirror arrangement for a MOT according to an embodiment of the present invention;

FIG. 2 shows a comparison of the proposed mirror geometry according to an embodiment of the present invention with a pyramid shaped mirror;

FIG. 3 shows a laser assembly including a mirror arrangement according to an embodiment of the present invention for forming a three dimensional MOT;

FIG. 4 shows part of the laser assembly including a quarter wave plate (QWP) for adjusting light polarization, magnetic field direction, corresponding handedness of beam polarizations and mirror arrangement shown in FIG. 3;

FIG. 5 shows a laser assembly including QWP and a mirror arrangement according to an embodiment of the present invention for forming a three dimensional MOT;

FIG. 6A to FIG. 6F show a mirror arrangement according to an embodiment of the present invention which provides a three dimensional arrangement of mirrors for a MOT;

FIG. 7A and FIG. 7B configurations of a laser assembly and a three dimensional mirror arrangement according to embodiments of the present invention which provide a MOT;

FIG. 8A and FIG. 8B show the relative arrangement and orientation of deflector mirrors and combiner mirrors in embodiments of the present invention;

FIG. 9 shows dimensions of a mirror arrangement according to an embodiment of the present invention;

FIG. 10 shows a mirror arrangement for a MOT having a cut out section according to an embodiment of the present invention;

FIG. 11A and FIG. 11B show examples of cut out sections in embodiments of the present invention;

FIG. 12 shows a laser assembly including mirror arrangement with a cut out section according to an embodiment of the present invention;

FIG. 13A and FIG. 13B show mirror arrangements which provide a three dimensional beam pattern for a MOT with a cut out according to embodiments of the present invention.

FIG. 14 shows a mirror arrangement inside a vacuum chamber with relative placement of the gaseous atom dispensers; and

FIG. 15A to FIG. 15C show beam polarizations and QWP arrangements between deflector and combiner mirrors in embodiments of present inventions.

### DETAILED DESCRIPTION

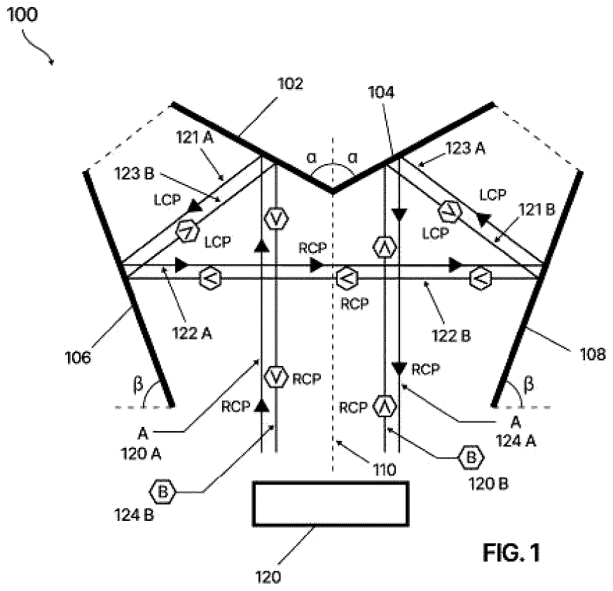

FIG. 1 shows a mirror arrangement for a magneto-optical trap according to an embodiment of the present invention. The mirror arrangement 100 has an optical axis 110 and comprises a first deflector mirror 102, a second deflector mirror 104, a first combiner mirror 106 and a second combiner mirror 108.

The first deflector mirror 102 and the second deflector mirror 104 are planar mirrors arranged with a reflective surface at an obtuse angle to the optical axis 110 of the mirror arrangement 100. In the arrangement shown in FIG. 1, the first deflector mirror 102 and the second deflector mirror 104 meet at the optical axis 110, however as described in more detail below, in some embodiments, a slit or an opening is provided between the deflector mirror 102 and the second deflector mirror 104. As shown in FIG. 1, the first deflector mirror 102 and the second deflector mirror 104 are symmetrically arranged with respect to the optical axis 110.

The first combiner mirror 106 and the second combiner mirror 108 are planar mirrors which have a reflective surface. The reflective surface of the first combiner mirror 106 faces the reflective surface of the first deflector mirror 102 and is arranged at an acute angle relative to the reflective surface of the first deflector mirror 102. Similarly, the reflective surface of the second combiner mirror 108 faces the reflective surface of the second deflector mirror 104 and is arranged at an acute angle relative to the reflective surface of the second deflector mirror 104. As shown in FIG. 1, the first combiner mirror 106 and the second combiner mirror 108 are arranged symmetrically with respect to the optical axis 110.

In use, a collimated laser light source 120 is positioned to provide illumination along the direction of the optical axis 110 of the mirror arrangement 100. As shown in FIG. 1, the laser light source 120 provides illumination which is shown as ray A and ray B. Ray A and Ray B are overlapping but shown separately for easier understanding of direction of the beam.

The incoming ray A 120A and the incoming ray B 120B may be considered to be a source beam leaving the laser light source 120. The source beam is circularly polarized. In the configuration shown in FIG. 1, the incoming ray A 120A and the incoming ray B are right-handed circularly polarized (RCP). As shown in FIG. 1, the incoming ray A 120 travels from the laser light source 120 and is deflected by the first deflector mirror 102 in a first deflected direction as a first deflected beam 121A. The reflection by the first deflector mirror 102 causes a change in circular polarization. Thus, right-handed circularly polarized (RCP) of the incoming ray A 120A becomes left-handed circularly polarized (LCP) of the first deflected beam 121A. The incoming ray B travels from the laser light source 120 and is deflected by the second deflector mirror 104 in a second deflected direction as a second deflected beam 121B. The reflection causes a change in circular polarization so the right-handed circularly polarized (RCP) of incoming ray B 120B is reflected as left-handed circularly polarized (LCP) second deflected beam 121B.

The first deflected beam 121A travels from the first deflector mirror 102 towards the first combiner mirror 106. The first deflected beam 121A is then deflected by the first combiner mirror 106 in a first orthogonal direction as a first orthogonal beam 122A. Again, the reflection causes a change in circular polarization so the first orthogonal beam 122A is right-handed circularly polarized (RCP). The first orthogonal direction is orthogonal to the source beam (and also the optical axis 110).

The second deflected beam 121B travels from the second deflector mirror 104 towards the second combiner mirror 108. The second deflected beam 121B is then deflected by the second combiner mirror 108 in a second orthogonal direction as a second orthogonal beam 122B. The second orthogonal beam 122B is right-handed circularly polarized (RCP). The second orthogonal direction is orthogonal to the source beam (and also the optical axis 110).

The first orthogonal beam 122A travels from the first combiner mirror 106 in the first orthogonal direction towards the second combiner mirror 108. The first orthogonal beam is then deflected by the second combiner mirror 108 as a first re-deflected beam 123A in a direction towards the second deflector mirror 104. The first re-deflected beam 123A is left-handed circularly polarized (LCP).

The second orthogonal beam 122B travels from the second combiner mirror 108 in the second orthogonal direction towards the first combiner mirror 106. The second orthogonal beam 122B is then deflected by the first combiner mirror as a second re-deflected beam 123B in a direction towards the first deflector mirror 102. The second re-deflected beam 123B is left-handed circularly polarized (LCP).

The first re-deflected beam 123A travels from the second combiner mirror 108 towards the second deflector mirror 104. The first re-deflected beam 123A is deflected by the second deflector mirror 104 as part of an outgoing beam 124A in a direction opposing the direction of the source beam. The outgoing beam 124A is right-handed circularly polarized (RCP).

The second re-deflected beam 123B travels from the first combiner mirror 106 towards the first deflector mirror 102. The second re-deflected beam 123B is deflected by the first deflector mirror 102 as part of the outgoing beam 124B in the direction opposing the direction of the source beam. The outgoing beam 124B is right-handed circularly polarized (RCP).

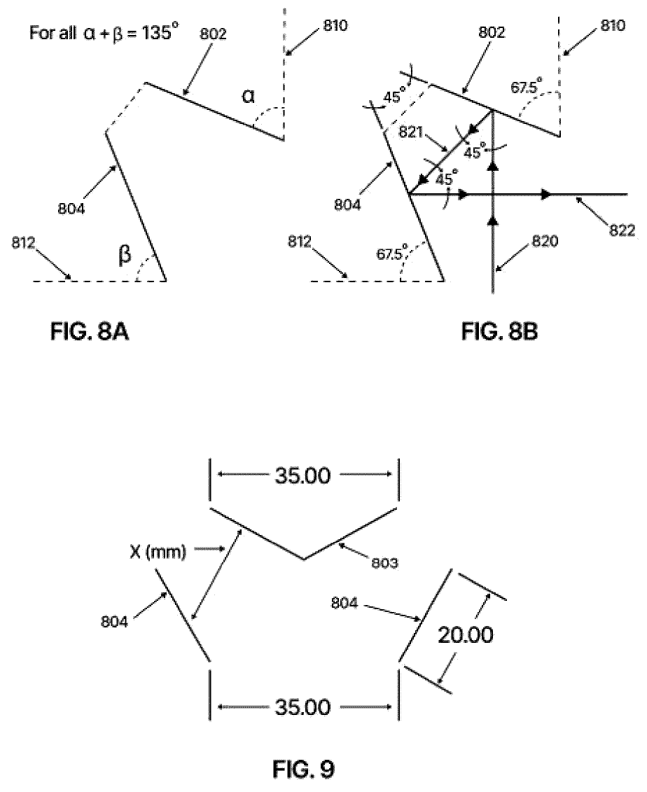

As described above, the first deflector mirror 102, the second deflector mirror 104, the first combiner mirror 106 and the second combiner mirror 108 are orientated such that the source beam, first orthogonal beam 122A, the second orthogonal beam 122B and the outgoing beam provide two pairs of mutually orthogonal beams. Thus, the mirror arrangement 100 shown in FIG. 1 allows a single laser source 120 to provide two pairs of counter-propagating and mutually orthogonal beams and two additional pairs of counter-propagating beams with the same handedness of the circular polarization in a plane (the plane of FIG. 1). In order for the orientation of the beams to be mutually orthogonal as shown in FIG. 1, the relationship between the angles α and β is set as described below with reference to FIGS. 8A and 8B.

The region in the center of the mirror arrangement 100 where the mutually orthogonal beams meet may be considered a trap region.

In addition, since the beams are reflected two times before each time they pass through the trap region, the handedness of their polarization is the same for each beam in the trap region. In the example shown in FIG. 1, the beams passing through the trap region are each right-handed circularly polarized (RCP). It will be appreciated that if the incoming ray A 120A and the incoming ray B 120B are each left-handed circularly polarized (LCP), the handedness of the polarizations in the trap region would also be left-handed circularly polarized (LCP).

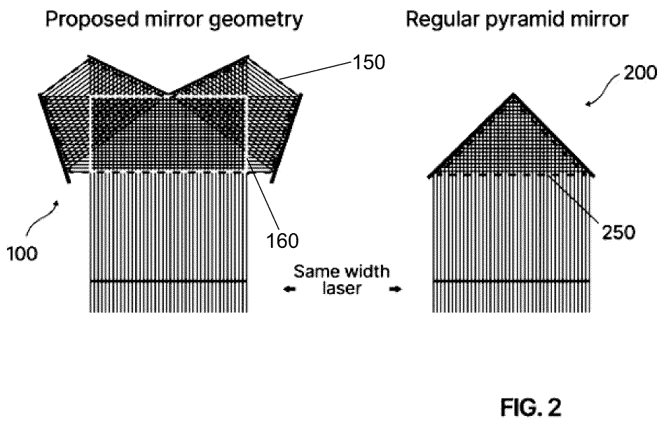

FIG. 2 shows a comparison of the proposed mirror geometry according to an embodiment of the present invention with a pyramid shaped mirror.

As shown in FIG. 2, the proposed mirror arrangement 100 provides a larger cooling and trapping area 150 than the area 250 provided by a pyramid mirror arrangement for the incoming laser with the same beam diameter. Compared to a regular pyramid mirror, the proposed geometry generates more intersection volume with counterpropagating beams because of additional reflection and generates more intersection volume. A glass cell 160 is arranged within the mirror arrangement 100 to provide a vacuum environment.

In addition, in the proposed geometry, there are gaps between deflector and combiner mirrors for example. This clear access can be used to inject gaseous atoms, image and monitor the magneto-optical trap, shine lasers to impart momentum kicks or to do interferometry etc. This clear access is not present in regular pyramid mirrors.

In some embodiments, the mirror arrangement is formed as a discrete device with support structures coupling the deflector mirrors to the combiner mirrors. This allows the relative orientations between the mirrors to be fixed. In other embodiments, the mirrors are separately mounted. Such an arrangement allows the mirrors to be provided outside a vacuum chamber in which the magneto-optical trap is formed.

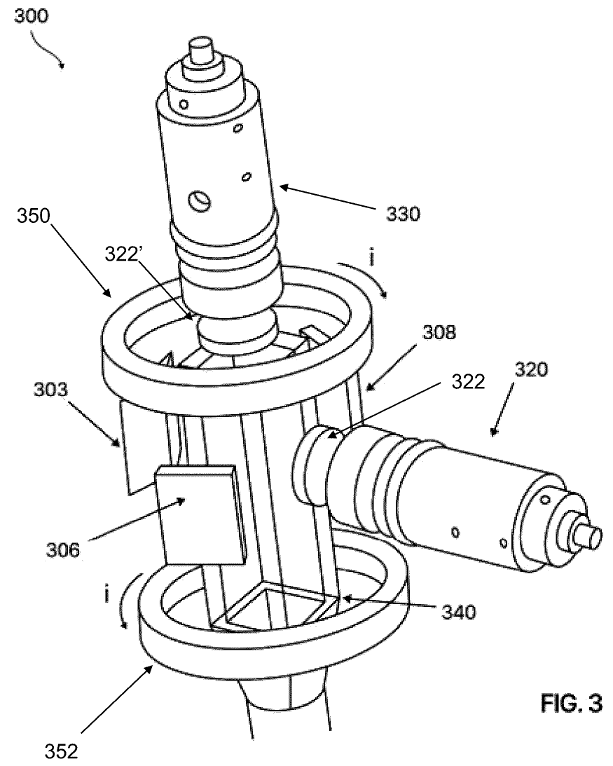

FIG. 3 shows a laser assembly including a mirror arrangement according to an embodiment of the present invention for forming a three dimensional magneto-optical trap.

As shown in FIG. 3, the laser assembly 300 comprises a horizontal laser collimator 320 and a vertical laser collimator 330. A QWP 322 is arranged in front of the horizontal laser collimator 320 and a QWP 322′ is arranged in front of the vertical laser collimator 330. A glass cell 340 provides a vacuum chamber in which the magneto-optical trap is formed. As shown in FIG. 3, a deflector mirror block 303 has two reflective faces arranged adjacent to each other which respectively form the first deflector mirror and the second deflector mirror described above with reference to FIG. 1. The first combiner mirror 306 and the second combiner mirror 308 are formed as separate components. As shown in FIG. 3, the deflector mirror block 303, the first combiner mirror 306 and the second combiner mirror 308 are arranged outside the glass cell 340. The horizontal laser collimator 320, the deflector mirror block 303, the first combiner mirror 306 and the second combiner mirror 308 are arranged in a horizontal plane on opposing sides of the glass cell 340.

Two circular magnetic coils: a first magnetic coil 350 and a second magnetic coil 352 are provided above and below the mirror arrangement. The first magnetic coil 350 and the second magnetic coil 352 are arranged along the same axis (which is perpendicular to the plane of the mirror arrangement, and the current i flowing in the coils flows in opposing directions. This configuration of coils provides a magnetic field gradient along the x, y and z-axis near the trap center. The coils are placed such that the zero point of the magnetic field overlaps with the intersection of the orthogonal beams.

In operation, the beam from the horizontal laser collimator 320 passes through the glass cell 340, to the deflector mirror block 303, and is then deflected towards the first combiner mirror 306 and the second combiner mirror 308. The deflected beams are then directed through the glass cell 340 by the first combiner mirror 306 and the second combiner mirror 308.

The vertical laser collimator 330 provides a beam which passes through the glass cell 340 vertically and is reflected back into the glass cell 340 by a mirror (not shown in FIG. 3) located at the bottom of the laser assembly 300.

FIG. 4 shows part of the laser assembly and mirror arrangement shown in FIG. 3. The QWP 322 converts the linearly polarized beam from the horizontal laser collimator 320 to a circularly polarized beam. As shown in FIG. 4, the circularly polarized beam from the horizontal laser collimator is deflected by the reflective faces of the deflector mirror block 303 towards the first combiner mirror 306 and the second combiner mirror 308. A magneto-optical trap 360 is formed where four beams meet as two pairs of opposing beams from orthogonal axes in the horizontal plane. The vertical collimator 330 and opposing mirror provide a third pair of opposing beams which together with the two pairs of beams in the horizontal plane form a three dimensional magneto-optical trap.

The circular direction behind each arrow indicating a beam shows the handedness of circular polarizations, and the σ+ and σ− notation indicate the atomic transitions caused by a given circularly polarized light in presence of the corresponding direction of the magnetic field. The axes in FIG. 4 show the magnetic field directions from the magnetic coils 350 and 352.

σ+ and σ− indicate specific atomic transitions. These atomic transitions generate an imbalance in the force from the opposing light beams. This imbalanced force pushes the atoms towards the trap center. Considering, for example, a single axis at each point in the trap region there are beams coming from both directions. Atoms can take momentum kicks from both directions. A kick from one side occurs due to σ+ transition and vice versa. At center the effective force from σ+ and σ− transition will be the same because the magnetic field is zero. If an atom moves in either direction away from the center of the trap, the force due to σ+ or σ− will increase depending on the direction of the magnetic field and this force will cause the atom to move back towards the center of the trap.

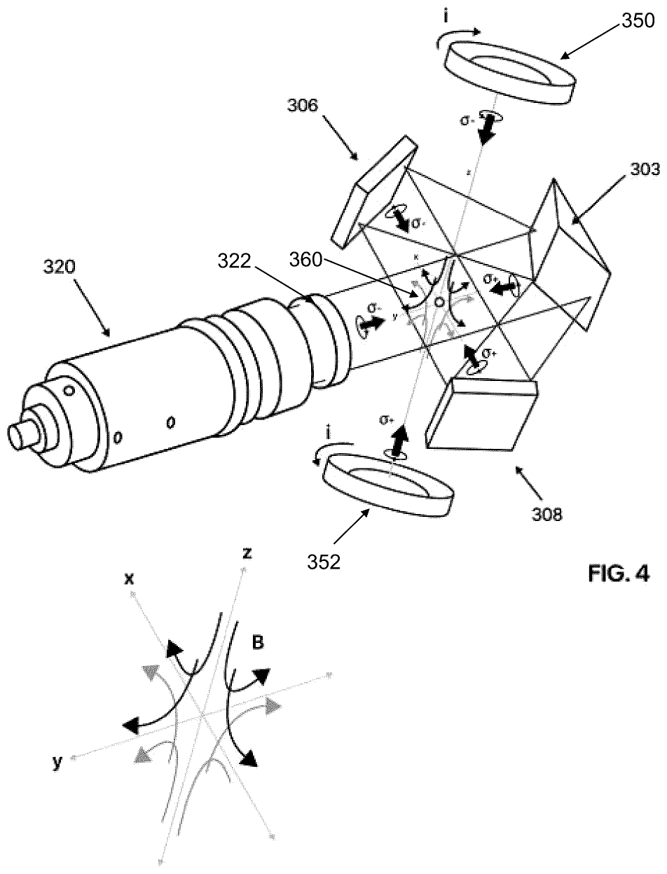

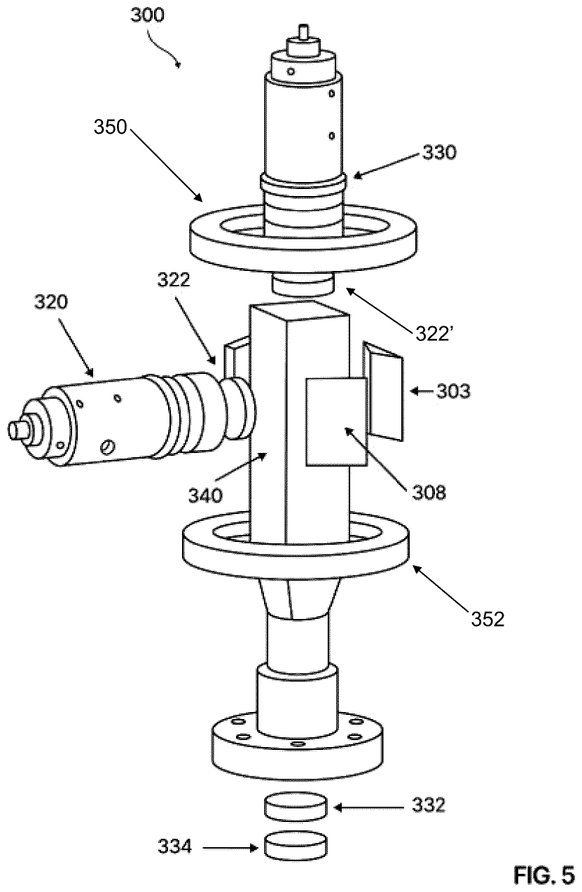

FIG. 5 shows a laser assembly including waveplates for adjusting light polarization and a mirror arrangement according to an embodiment of the present invention for forming a three dimensional MOT. As shown in FIG. 5, the laser assembly 300 comprises a quarter wave plate 322 arranged in front of the horizontal laser collimator 320. The waveplate 322 allows conversion of the polarization of the light from the horizontal laser collimator 320 from linear polarization to circular polarization before it passes through the glass cell 340 and is deflected by the reflective faces of the deflector mirror block 303 and the first combiner mirror and the second combiner mirror 308. A vertical laser collimator 330 is arranged to transmit a beam vertically through the glass cell 340. A quarter wave plate 322′ is arranged in front of the vertical laser collimator 330. As shown in FIG. 5, a mirror 334 is arranged at the bottom of the assembly 300. The mirror 334 reflects light from the vertical laser collimator 330 back into the glass cell 340 after it has passed downward through the glass cell 340. A wave plate 332 is arranged above the mirror 334 to adjust the polarization of the light emitted from the vertical laser collimator 330. The magnetic coils 350 and 352 are located around the axis of the vertical laser collimator.

As described above, a four mirror arrangement generates a planar beam pattern for a magneto-optical trap. Embodiments of the present disclosure can be modified to include additional reflectors to provide a three dimensional beam pattern which provides six beams in three mutually orthogonal directions. This removes the requirement for a second laser collimator to provide the third set of beams in the vertical direction.

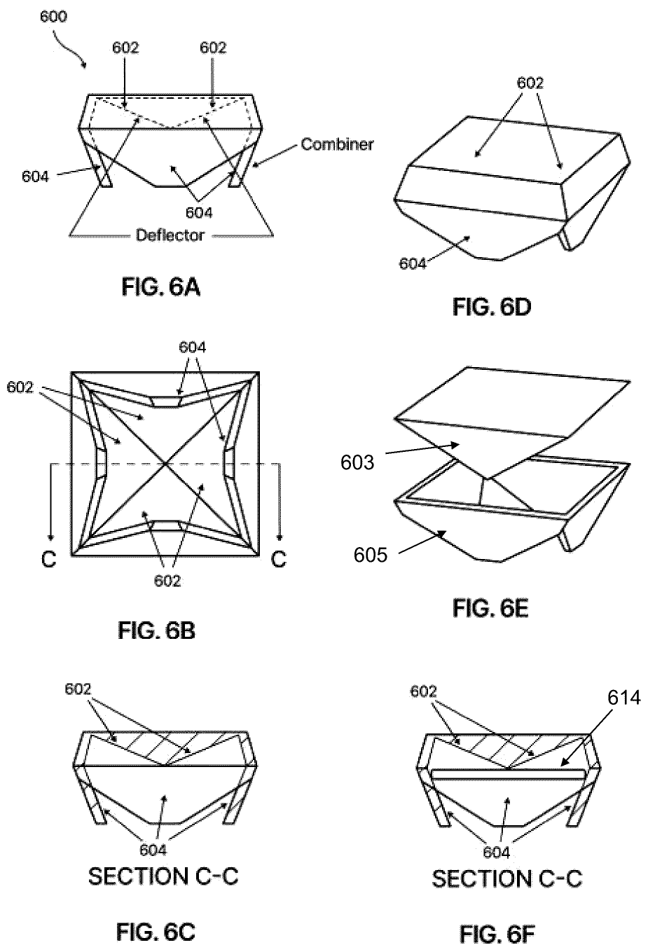

FIG. 6A to FIG. 6F show a mirror arrangement according to an embodiment of the present invention which provides a three dimensional beam pattern for a MOT.

FIG. 6A is a side view of the mirror arrangement, FIG. 6B is a top view of the mirror arrangement, FIG. 6C is a cross sectional view of the mirror arrangement across the section C-C shown in FIG. 6B and FIG. 6D is a perspective view of the mirror arrangement. FIG. 6E shows an embodiment in which the deflector mirrors and combiner mirrors are formed as separate parts. FIG. 6F shows an embodiment including a QWP in front of the deflector mirrors.

The mirror arrangement 600 comprises four deflector mirrors 602 which are each triangular in shape and formed into a pyramid structure. Four combiner mirrors 604 are arranged above the deflector mirrors 602 such that the arrangement 600 acts to deflect an incoming beam in both a horizontal plane and in a vertical plane to form a three dimensional trap with a single laser collimator.

The mirror arrangement 600 shown in FIG. 6A to 6D may be considered to comprise a first deflector mirror, a second deflector mirror, a third deflector mirror and a fourth deflector mirror. Similarly, the mirror arrangement further comprises a first combiner mirror, a second combiner mirror, a third combiner mirror and a fourth combiner mirror. The first deflector mirror, the second deflector mirror, the first combiner mirror, and the second combiner mirror are arranged to deflect an incoming beam in a first plane and the third deflector mirror, the fourth deflector mirror, the third combiner mirror and the fourth combiner mirror are arranged to deflect the incoming beam in a second plane which is perpendicular to the first plane. Thus, the mirror arrangement 600 shown in FIG. 6 operates as described above with reference to FIG. 1 in the first plane and additionally operates in an analogous way in the second plane.

As shown in FIG. 6A-FIG. 6D, the combiner mirrors 604 and a generally triangular shape with a corner facing outwards being truncated to maximize the beam width of an incoming beam.

As shown in FIG. 6E, the deflector mirrors may be formed from a pyramid shaped component 603 and the combiner mirrors may be from a separate combiner mirror component 605.

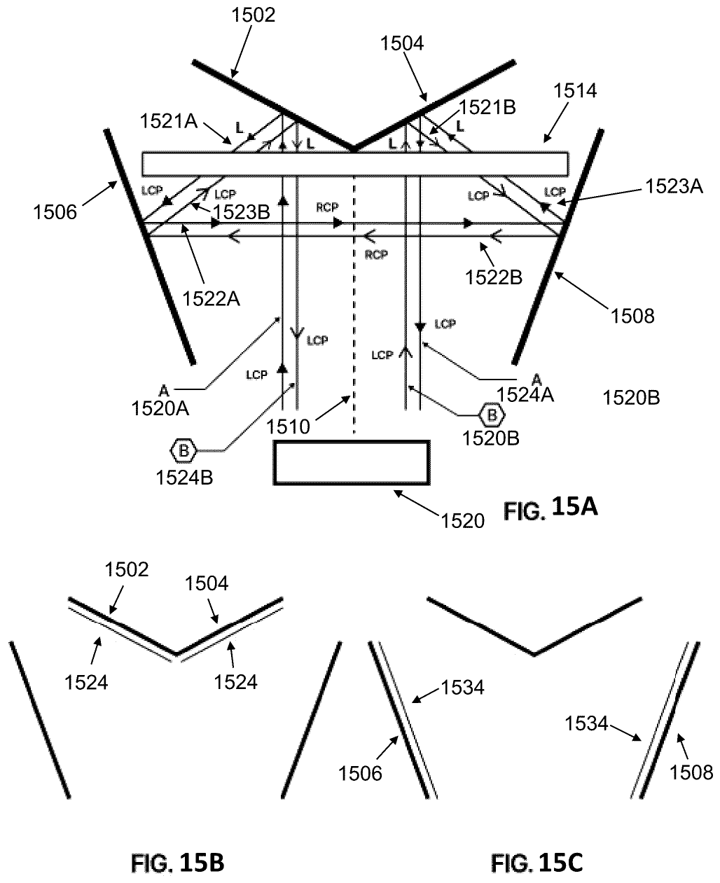

As shown in FIG. 6F, in an embodiment of the mirror arrangement, a QWP 614 is provided between the deflector mirrors 602 and the combiner mirrors 604. The QWP 614 functions to convert the circular polarization of the light beam in the vertical direction relative to the horizontal direction as is described in more detail below with reference to FIG. 15A.

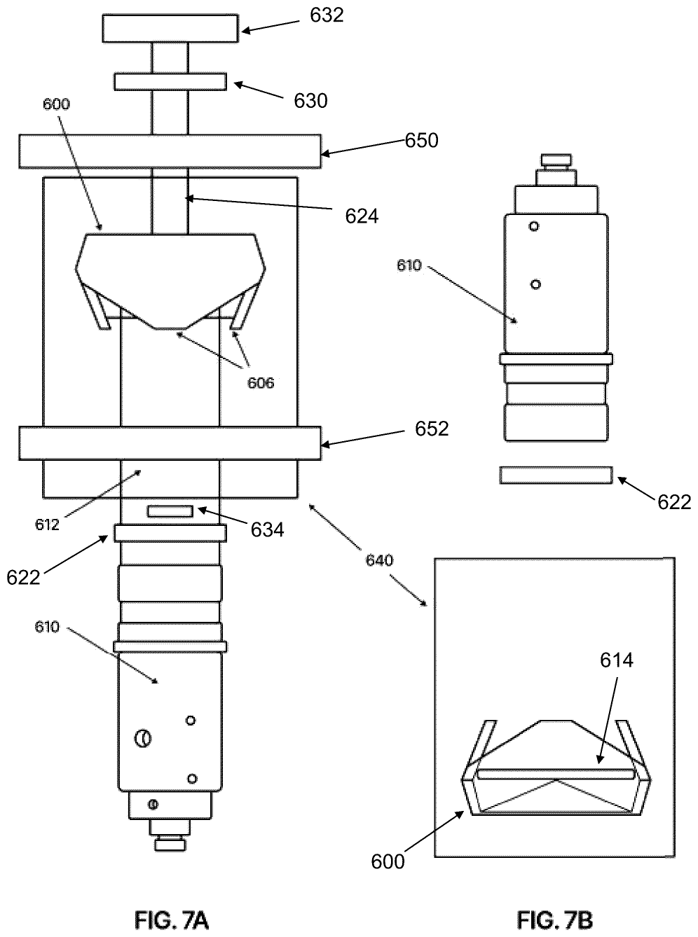

FIG. 7A and FIG. 7B show the mirror arrangement in combination with a laser collimator.

As shown in FIG. 7A, the mirror arrangement 600 is arranged inside a glass cell 640 which forms a vacuum chamber. The laser collimator 610 is arranged facing the opening formed by the combiner mirrors and the beam 612 from the laser collimator 610 passes between the combiner mirrors and is incident on the deflector mirrors. The truncated corners 606 of the combiner mirrors allow the width of the beam 612 entering the mirror arrangement 600 to be maximized.

In the arrangement shown in FIG. 7A, a QWP 622 is arranged in front of the laser collimator 610 to convert the incoming beam to circularly polarized. A half wave plate 634 is arranged in front of the quarter wave plate 622. The half wave plate 634 is narrower than the beam emitted by the laser collimator 610, thus the resulting incoming beam 612 is circularly polarized in one direction in the center of the beam and circularly polarized in the opposing direction in the peripheral part of the beam. An opening is provided in the mirror arrangement 600 which allows the central part 624 of the incoming beam 612 to be transmitted through the mirror arrangement which passes through a quarter wave plate 630 and is retro-reflected by a retroreflector mirror 632, the peripheral part of the beam is reflected by the deflector mirrors of the mirror arrangement 600. This allows for adjustment of the circular polarization of the beam in the direction of the z-axis. As described above with reference to FIG. 4, the direction of magnetic field along the z-axis is opposite compared to axes in the horizontal plane, the handedness of the circular polarization of the beam therefore must be adjusted accordingly.

In the arrangement shown in FIG. 7B, a quarter wave plate 622 is arranged in front of the laser collimator 610 to convert the emitted beam to circularly polarized. A QWP 614 is also arranged between the deflector mirrors and the combiner mirrors of the mirror arrangement 600. As described in more detail below with reference to FIG. 15A, this arrangement also allows for adjustment of the circular polarization of the beam in the direction of the z-axis.

FIG. 8A to FIG. 8B show the relative arrangement and orientation of deflector mirrors and combiner mirrors in embodiments of the present invention.

For the mirror arrangement to generate orthogonal sets of laser beams, the incoming ray must be reflected by 90° in total. In order for this reflection to occur, the sum of the angles α and β shown in FIG. 8A must satisfy α+β=135°.

As shown in FIG. 8A, a is the angle between the optical axis 810 of the mirror arrangement and the back (non-reflective surface) of the deflector mirror 802 and β is the angle between the back (non-reflective surface) of the combiner mirror 804 and an axis 812 normal to the optical axis 810 of the mirror arrangement.

FIG. 8B shows an example arrangement in which the angles are α=β=67.5°. As shown in FIG. 8B, the angle between the reflective surfaces of the deflector mirror 802 and the combiner mirror 804 is 45°. As shown in FIG. 8B, an incoming beam 820 parallel to the optical axis 810 is deflected by 45° by the deflector mirror 802 as a deflected beam 821 which travels towards the combiner mirror 804. The deflected beam 821 is deflected by 45° by the combiner mirror 804. Thus, the incoming beam 820 is deflected in total by 90° to form an orthogonal beam 822 which travels in the direction of the axis 812 normal to the optical axis 810 of the mirror arrangement.

It will be appreciated that while FIG. 8A and FIG. 8B, show one deflector mirror 802 and one combiner mirror 804, the relative orientations of the mirrors can be incorporated into the 4 mirror arrangement shown in FIG. 1 or the 8 mirror arrangement shown in FIG. 6A-6F.

FIG. 9 shows dimensions of a mirror arrangement according to an embodiment of the present invention. As shown in FIG. 9, the width of the deflector mirror block 803 is 35 mm, the width of each of the combiner mirrors is 20 mm and the separation of the combiner mirrors is 35 mm. The separation x of the combiner mirrors from the deflector mirror block 803 can be varied depending on the design requirements, for instance, the geometry and dimensions of the vacuum chamber in which the magneto-optical trap is formed.

Preferably for construction, fused silica, sapphire or zerodur may be used with dielectric high-reflection film having the reflectance of P light and S light greater than 98% for the optical beam used at the same time for beams incident at an angle of 22.5° for example with the normal of each mirror.

In some embodiments, a cut out section is provided in the deflector mirror block or between two separate deflector mirrors. The cut out section is provided on the central vertex of the deflector mirror block. The cut out provides a passage channel for cold atoms and laser beams. The cut section shape can be square, circle, slit etc. The joining line of the two deflector is made like a knife edge to minimize edge defects during reflection. This solution is not 100 percent accurate, thus for higher uniformity of the central beam, a circular or rectangular cut-out is made.

FIG. 10 shows a mirror arrangement for a magneto-optical trap having a cut out section according to an embodiment of the present invention. As shown in FIG. 10, the mirror arrangement 1000 comprises a first deflector mirror 1002, a second deflector mirror 1004, a first combiner mirror 1006 and a second combiner mirror 1008. A cut out 1009 is provided between the first deflector mirror 1002 and the second deflector mirror 1004. Part of an incoming laser beam 1020 running along the optical axis of the mirror arrangement 1000 will pass through the cut out 1009 and is reflected back into the optical trap as a reflected beam 1021 by a retroreflector (not shown in FIG. 10). Parts of the laser beam laterally displaced from the optical axis of the mirror arrangement will be deflected by the first deflector mirror 1002 or the second deflector mirror 1004 towards respectively the first combiner mirror 1006 or the second deflector mirror 1008 as described above with reference to FIG. 1.

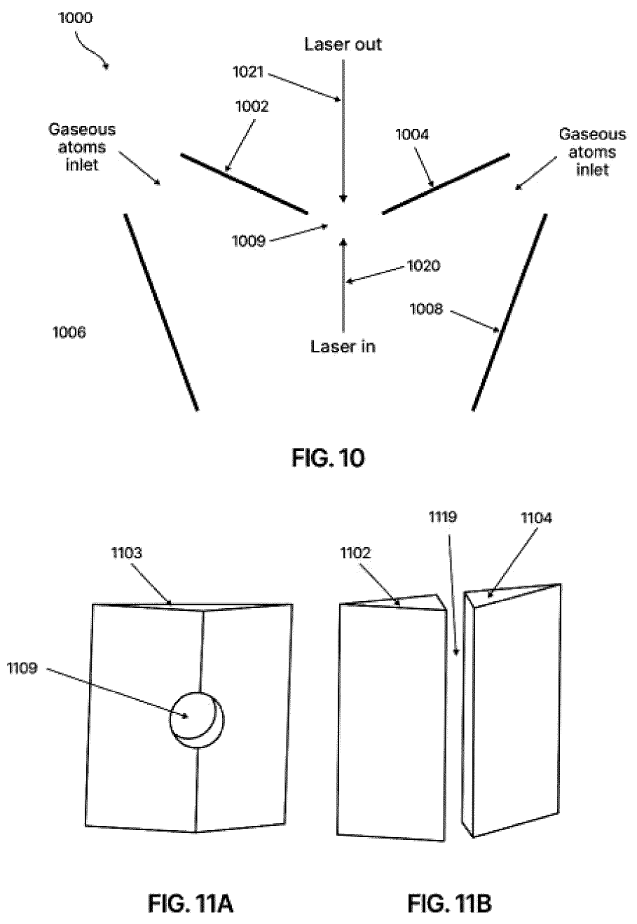

FIG. 11A and FIG. 11B show examples of cut out sections in embodiments of the present invention. As shown in FIG. 11A, in one embodiment a deflector mirror block 1103 which has two deflector mirror faces is provided with a cut out formed as a circular hole 1109 located at the join between the two deflector mirror faces.

As shown in FIG. 11B, in another embodiment, two separate deflector mirrors are provided as a first deflector mirror 1102 and a second deflector mirror 1104. A cut out is provided as a slit 1119 between the first deflector mirror 1102 and the second deflector mirror 1104.

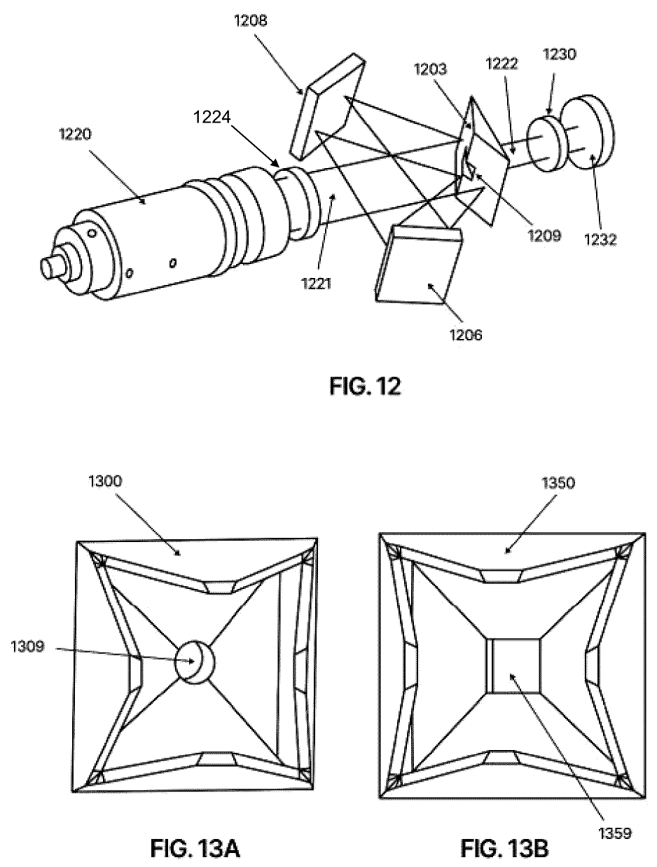

FIG. 12 shows a laser assembly including mirror arrangement with a cut out section according to an embodiment of the present invention. As shown in FIG. 12, the laser assembly comprises a laser collimator 1220, a QWP provided in front of the laser collimator 1220, a deflector mirror block 1203, a first combiner mirror 1306, a second combiner mirror 1208, a waveplate 1230 and a retroreflector mirror 1232. The deflector mirror block 1203 is provided with a cut out hole 1209 as described above with reference to FIG. 10 and FIG. 11A.

Part of the beam 1221 from the laser collimator 1220 passes through the cut out hole 1209 as an undeflected beam 1222. This undeflected beam 1222 is incident on the waveplate which will modify the polarization and is reflected back towards the laser collimator by the retroreflector mirror 1232. The part of the beam 1221 which are incident on the reflective faces of the deflector mirror block 1203 are deflected towards either the first combiner mirror 1206 or the second combiner mirror 1208 as described above with reference to FIG. 1.

The mirror arrangement shown in FIG. 6A-FIG. 6D which provides a three dimensional beam pattern for a magneto-optical trap may also be provided with a cut out.

FIG. 13A and FIG. 13B show mirror arrangements which provide a three dimensional beam pattern for a magneto-optical trap with a cut out according to embodiments of the present invention.

As shown in FIG. 13A, the mirror arrangement 1300 is provided with a circular cut out 1309 located at the region where the four triangular deflector mirror faces meet.

As shown in FIG. 13B, the mirror arrangement 1350 is provided with a square cut out 1359 located at the region where the four triangular deflector mirror faces meet.

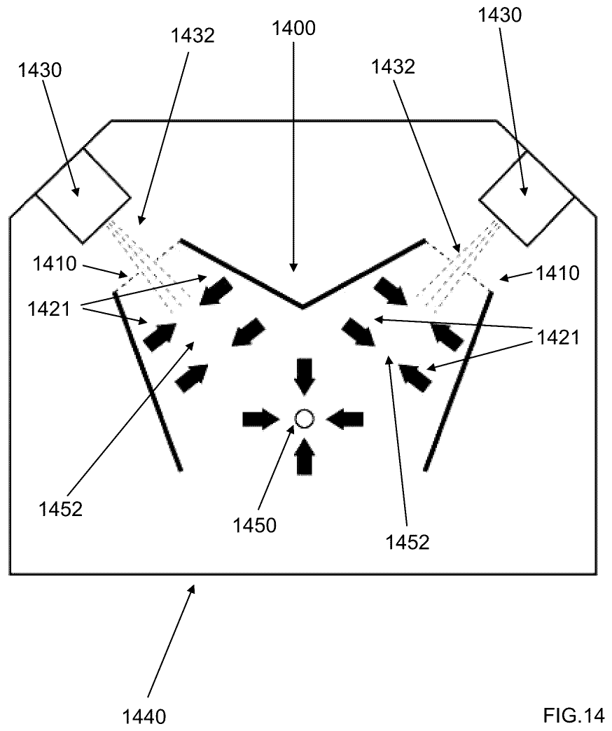

FIG. 14 shows a mirror arrangement according to an embodiment on the present invention combined with atom dispensers. As shown in FIG. 14, the mirror arrangement 1400 is provided in a cell 1440 which acts as a vacuum chamber. Two atom sources 1430 are arranged to emit a stream 1432 of gaseous atoms towards the trap region 1450 at the center of the mirror arrangement 1400. A gap 1410 is provided between the deflector mirrors and the combiner mirrors. The streams 1432 of gaseous atoms pass through this gap 1410. Inside the mirror arrangement, pairs of opposing beams 1421 which correspond to the first deflected beam 121A and the second re-deflected beam 123B or the second deflected beam 121B and the first re-deflected beam 123A shown in FIG. 1, is incident on the streams 1432. These pairs of beams may have a cooling and aligning effect on the atom streams 1432 as they travel towards the trap region 1450. Thus the streams 1432 are cooled and focused when they arrive at the trap region 1450.

FIG. 15A to FIG. 15C show mirror arrangements according to embodiments of the present invention with a QWP provided between the deflector mirrors and combiner mirrors.

As shown in FIG. 15A, a QWP 1514 is provided between the deflector mirrors (the first deflector mirror 1502 and the second deflector mirror 1504) and the combiner mirrors (the first combiner 1506 and the second combiner mirror 1506). A collimated laser light source 1520 provides illumination which is shown as ray A and ray B. Ray A and Ray B are overlapping but shown separately for easier understanding of direction of the beam.

The incoming ray A 1520A and the incoming ray B 1520B may be considered to be a source beam leaving the laser light source 1520. The source beam is circularly polarized. In the configuration shown in FIG. 15A, the incoming ray A 1520A and the incoming ray B are left-handed circularly polarized (LCP). The incoming ray A 1520A travels from the laser light source 1520 and passes through the QWP 1514. The QWP 1514 changes the polarization of the incoming ray A 1520A from LCP to linear polarized (L). The linear polarized incoming ray A 1520A is then deflected by the first deflector mirror 1502 in a first deflected direction as a first deflected beam 1521A. The first deflected beam 1521A is linear (L) polarized. The L polarized first deflected beam 1521A then passes through the quarter wave plate 1514. The quarter wave plate 1514 changes the polarization to LCP. The LCP first deflected beam 1521A is then deflected by the first combiner mirror 1506 in a first orthogonal direction as a first orthogonal beam 1522A. The reflection causes a change in circular polarization so the first orthogonal beam 1522A is right-handed circularly polarized (RCP). The first orthogonal direction is orthogonal to the source beam (and also the optical axis 1510).

The first orthogonal beam 1522A travels from the first combiner mirror 1506 in the first orthogonal direction towards the second combiner mirror 1508. The first orthogonal beam is then deflected by the second combiner mirror 1508 as a first re-deflected beam 1523A in a direction towards the second deflector mirror 1504. The first re-deflected beam 1523A is left-handed circularly polarized (LCP). The first re-deflected beam 1523A passes through the quarter wave plate 1514. The quarter wave plate 1514 changes the polarization of the first re-deflected beam 1523A from LCP to linear polarized (L). The L polarized first re-deflected beam 1523A is then deflected by the second deflector mirror 1504 as part of an outgoing beam 1524A in a direction opposing the direction of the source beam. The outgoing beam 1524A is L polarized when deflected by the second deflector mirror 1504. The outgoing beam 1524A then passes through the quarter wave plate 1514. The quarter wave plate 1514 changes the polarization of the outgoing beam 1524A from linear polarized (L) to LCP. Thus, the outgoing beam is LCP polarized as it passes through the trap region.

The polarization of the incoming ray B 1520B changes in an analogous way as it passes through the quarter wave plate 1514 and is deflected by the deflector mirrors and combiner mirrors. The incoming ray B 1520B travels from the laser light source 1520 and passes through the quarter wave plate 1514. The quarter wave plate 1514 changes the polarization of the incoming ray B 1520B from LCP to linear polarized (L). The linear polarized incoming ray A 1520B is then deflected by the second deflector mirror 1504 in a second deflected direction as a second deflected beam 1521B. The second deflected beam 1521B is linear (L) polarized. The L polarized second deflected beam 1521B then passes through the quarter wave plate 1514. The quarter wave plate 1514 changes the polarization to LCP. The LCP second deflected beam 1521B is then deflected by the second combiner mirror 1508 in a second orthogonal direction as a second orthogonal beam 1522B. The reflection causes a change in circular polarization so the second orthogonal beam 1522B is right-handed circularly polarized (RCP). The second orthogonal direction is orthogonal to the source beam (and also the optical axis 1510).

The second orthogonal beam 1522B travels from the second combiner mirror 1508 in the second orthogonal direction towards the first combiner mirror 1506. The second orthogonal beam is then deflected by the first combiner mirror 1506 as a second re-deflected beam 1523B in a direction towards the first deflector mirror 1502. The second re-deflected beam 1523B is left-handed circularly polarized (LCP). The second re-deflected beam 1523B passes through the quarter wave plate 1514. The quarter wave plate 1514 changes the polarization of the second re-deflected beam 1523B from LCP to linear polarized (L). The L polarized second re-deflected beam 1523B is then deflected by the second deflector mirror 1504 as part of an outgoing beam 124A in a direction opposing the direction of the source beam. The outgoing beam 1524B is L polarized when deflected by the first deflector mirror 1502. The outgoing beam 1524B then passes through the quarter wave plate 1514. The quarter wave plate 1514 changes the polarization of the outgoing beam 1524B from linear polarized (L) to LCP. Thus, the outgoing beam is LCP polarized as it passes through the trap region.

It will be appreciated that the mirror arrangement shown in FIG. 15A may correspond to the three dimensional mirror arrangement shown in FIG. 6A to FIG. 6F and thus the plane shown in FIG. 15A may correspond to a cross section through the mirror arrangement and the behavior of light rays in the perpendicular plane would be analogous to that shown in FIG. 15A.

As described above, the provision of the QWP 1514 between the deflector mirrors and the combiner mirrors allows the direction of circular polarization to be adjusted along the z-axis (which is the vertical axis in FIG. 15A).

The QWP may be provided as shown in FIG. 15A. Alternatively, the quarter wave plate may be provided as a QWP section provided parallel to either the deflector mirrors or the combiner mirrors.

FIG. 15B shows a mirror arrangement with QWPs provided parallel to the deflector mirrors according to an embodiment of the present invention. As shown in FIG. 15B, quarter wave plate sections 1524 are provided parallel to the first deflector mirror 1502 and the second deflector mirror 1504. It will be appreciated that additional QWP sections are provided parallel to the deflector mirrors in the planes not shown in FIG. 15B.

FIG. 15C shows a mirror arrangement with QWPs provided parallel to the combiner mirrors according to an embodiment of the present invention. As shown in FIG. 15C, QWP sections 1534 are provided parallel to the first combiner mirror 1506 and the second combiner mirror 1508. It will be appreciated that additional quarter wave plate sections are provided parallel to the combiner mirrors in the planes not shown in FIG. 15C. Whilst the foregoing description has described exemplary embodiments, it will be understood by those skilled in the art that many variations of the embodiments can be made within the scope and spirit of the present invention.

1. A mirror arrangement for a magneto-optical trap, the mirror arrangement comprising:
a first deflector mirror;
a second deflector mirror;
a first combiner mirror; and
a second combiner mirror,
the first deflector mirror being arranged to deflect part of a source beam, from a direction along an optical axis of the mirror arrangement to a first deflected direction, in a first plane, towards the first combiner mirror, as a first deflected beam,
the first combiner mirror being arranged to deflect the first deflected beam, in a first orthogonal direction in the first plane which is orthogonal to the direction of the source beam, as a first orthogonal beam,
the second deflector mirror being arranged to deflect part of the source beam, from the direction along the optical axis of the mirror arrangement, to a second deflected direction, in the first plane, towards the second combiner mirror, as a second deflected beam,
the second combiner mirror being arranged to deflect the second deflected beam, in a second orthogonal direction in the first plane which is orthogonal to the direction of the source beam, as a second orthogonal beam,
wherein the second combiner mirror is arranged to deflect the first orthogonal beam as a first re-deflected beam in a direction towards the second deflector mirror, the second deflector mirror is arranged to deflect the first re-deflected beam as part of an outgoing beam in a direction opposing the direction of the source beam, the first combiner mirror is arranged to deflect the second orthogonal beam as a second re-deflected beam in a direction towards the first deflector mirror, and the first deflector mirror is arranged to deflect the second re-deflected beam as part of the outgoing beam, such that the source beam and the outgoing beam form a first counter propagating beam pair in a trap location and the first orthogonal beam and the second orthogonal beam form a second counter propagating beam pair in the trap location which is orthogonal to the first counter propagating beam pair.

2. The mirror arrangement according to claim 1, wherein the first deflector mirror and the second deflector mirror are adjacent to one another.

3. The mirror arrangement according to claim 2, wherein a cut out section is provided between the first deflector mirror and the second deflector mirror.

4. The mirror arrangement according to claim 3, wherein the cut out section is in the form of hole or a slit.

5. The mirror arrangement according to claim 1, further comprising:
a third deflector mirror;
a fourth deflector mirror;
a third combiner mirror; and
a fourth combiner mirror,
the third deflector mirror being arranged to deflect part of a source beam, from the direction along the optical axis of the mirror arrangement to a third deflected direction, in a second plane which is perpendicular to the first plane, towards the third combiner mirror, as a third deflected beam,
the third combiner mirror being arranged to deflect the third deflected beam, in a third orthogonal direction in the second plane which is orthogonal to the direction of the source beam, as a third orthogonal beam,
the fourth deflector mirror being arranged to deflect part of the source beam, from the direction along the optical axis of the mirror arrangement, to a fourth deflected direction, in the second plane, towards the fourth combiner mirror, as a fourth deflected beam,
the fourth combiner mirror being arranged to deflect the fourth deflected beam, in a fourth orthogonal direction in the second plane which is orthogonal to the direction of the source beam, as a fourth orthogonal beam,
wherein the fourth combiner mirror is arranged to deflect the third orthogonal beam as a third re-deflected beam in a direction towards the fourth deflector mirror, the fourth deflector mirror is arranged to deflect the third re-deflected beam as part of the outgoing beam in the direction opposing the direction of the source beam, the third combiner mirror is arranged to deflect the fourth orthogonal beam as a fourth re-deflected beam in a direction towards the third deflector mirror, and the third deflector mirror is arranged to deflect the fourth re-deflected beam as part of the outgoing beam, such that the third orthogonal beam and the fourth orthogonal beam form a third counter propagating beam pair in the trap location which is orthogonal to the first counter propagating beam pair and the second counter propagating beam pair.

6. The mirror arrangement according to claim 5, wherein the first deflector mirror, the second deflector mirror, the third deflector mirror and the fourth deflector mirror are adjacent to one another.

7. The mirror arrangement according to claim 6, wherein the first deflector mirror, the second deflector mirror, the third deflector mirror and the fourth deflector mirror form a pyramid shape.

8. The mirror arrangement according to claim 7, wherein a cut out section is provided between the first deflector mirror, the second deflector mirror, the third deflector mirror and the fourth deflector mirror.

9. The mirror arrangement according to claim 3, wherein a retro-mirror is provided to retro-reflect a light beam passing through the cut out section.

10. The mirror arrangement according to claim 9, further comprising a waveplate configured to change a polarization of the light beam passing through the cut out section.

11. The mirror arrangement according to claim 1, wherein the first counter propagating beam pair, the second counter propagating beam pair and the third counter propagating beam pair (if applicable) are orthogonal within a tolerance of 1 degree, preferably within a tolerance of 0.1 degrees and more preferably within a tolerance of 0.01 degrees.

12. The mirror arrangement according to claim 1, further comprising a quarter wave plate arranged between the deflector mirrors and the combiner mirrors.

13. The mirror arrangement according to claim 12, wherein the quarter wave plate is provided as a plurality of quarter wave plate sections each provided parallel to a respective deflector mirror.

14. The mirror arrangement according to claim 12, wherein the quarter wave plate is provided as a plurality of quarter wave plate sections each provided parallel to a respective combiner mirror.

15. A magneto-optical trap comprising the mirror arrangement according to claim 1.

16. The magneto-optical trap according to claim 15, further comprising a vacuum chamber, wherein the mirror arrangement is provided within the vacuum chamber.

17. The magneto-optical trap according to claim 15, wherein the mirror arrangement is provided as a single structure.

18. The magneto-optical trap according to claim 15, further comprising a vacuum chamber, wherein the mirror arrangement is provided outside the vacuum chamber.

19. The magneto-optical trap according to claim 18, wherein the mirror arrangement is provided as a plurality of separate components.

20. The magneto-optical trap according to claim 15, further comprising a source of gaseous atoms arranged to emit a stream of atoms through a gap between a defector mirror and a combiner mirror of the mirror arrangement.
